(19) United States
(12) Patent Application Publication
(10) Pub. No.: US 2005/0188331 A1
(43) Pub. Date: Aug. 25, 2005

(54) Problem solving support apparatus and program

(76) Inventors: Kazumi Shimada, Tokyo (JP); Masakatsu Sato, Tokyo (JP)

Correspondence Address: OSHA LIANG L.L.P., 1221 MCKINNEY STREET, SUITE 2800, HOUSTON, TX, 77010, US

(21) Appl. No.: 10/885,157

(22) Filed: Jul. 6, 2004

(30) Foreign Application Priority Data
Feb. 24, 2004 (JP) 2004-048655

(51) Int. Cl. G06F 3/00; G06F 17/30

(52) U.S. Cl. 715/816; 715/739; 715/810; 715/846; 707/3

(57) ABSTRACT

Users of the portable phone 10 are allowed to promptly select and execute desired functions. A problem solution support apparatus 100 for supporting problem solutions for users of electronic device 10 based on user input on how to use the device. The apparatus includes: a related icon storage section which stores a plurality of icons, which are images with appearance conceptually associated with at least a part of an entry word, in association with the entry word which specifies the problem solving functions of the electronic device; a candidate icon display section which displays at least a part of plurality of icons that are candidates for accepting selections from outside on a screen; and an entry word extract section which refers to the related icon storage section to extract the entry word and display the extracted entry word based on combinations of two or more icons when the two or more icons are selected from icons on the screen displayed by the candidate icon display section, and the candidate icon display section sorts a plurality of icons to two or more groups and displays them.

The present application claims priority from a Japanese Patent Application No. 2004-048655 filed on Feb. 24, 2004, the contents of which are incorporated herein by reference.

### BACKGROUND OF THE INVENTION

1. Field of the Invention

The present invention relates to a problem solving support apparatus and program. More particularly, the present invention relates to a problem solving support apparatus and program for electronic device users based on user input on how to use the device.

2. Related Art

Conventionally, icons corresponding to each function of an electronic device, such as a portable phone, are displayed on the screen. When there are a number of functions of an electronic device some electronic devices hierarchically display icons corresponding to the upper level concepts of each function as disclosed, for example in Unexamined Japanese Patent Laid-Open Application No. 2003-108280. With such devices the upper level concepts of a function to be executed are first displayed on the screen. When the user selects one of the displayed icons, lower hierarchy icons are displayed on the screen. For example, when a user attempts to execute ‘send mail’ and a ‘mail’ icon is displayed on the screen the icon is selected. With this operation the lower hierarchy of ‘mail’, including ‘send mail’, is displayed on the screen. When the user selects the icon of ‘send mail’ the mail send function is executed.

However, the hierarchy of icons is preset by electronic device manufacturers. Therefore, unless users know this preset hierarchy it is difficult for them to find the desired functions.

### SUMMARY OF THE INVENTION

In order to solve above-mentioned problems, according to a first aspect of the present invention, a problem solving support apparatus for supporting problem solving for electric device users based on user input on how to use the device, includes: related icon storage section which stores a plurality of icons, which are images appearance conceptually associated with at least a part of an entry word, in association with the entry word which specifies problem solving functions of the electronic device; a candidate icon display section which displays at least a part of the plurality of icons that are candidates for accepting selections from outside on a screen; and an entry word extract section which refers to the related icon storage section to extract the entry word and display the extracted entry word based on combinations of two or more icons when the two or more icons are selected from the icons on the screen displayed by the candidate icon display section, and the candidate icon display section divides a plurality of icons into two or more groups and displays them separately.

The candidate icon display section in the related problem solution support apparatus may expand the display area of other groups when an icon is selected from one group of the two or more groups.

The related problem solution support apparatus may include a candidate icon regulating section which refers to a related icon storage section, extracts other icons which correspond to the entry word corresponding to the selected icon, compares the number of the icons in two or more groups which are distinguished by a candidate icon display section, and expands and displays the display area of the group with the greater number of extracted icons when an icon is selected from a group of two or more groups.

The candidate icon display section may display the first group of the two or more groups as a group of action icons indicating the action of the function specified by the entry word and display the second group of the two or more groups as a target icon group indicating the target of the function specified by the entry word.

The related icon storage section in the related problem solution support apparatus may distinguish action icons and target icons, associate each of them with entry words, and store them.

The related icon storage section in the related problem solution support apparatus may include an entry word storage section which associates action element words indicating the action of functions specified by entry words and target element words indicating the targets of functions specified by entry words with entry words and stores them and the corresponding element word storage section which stores target icons having an appearance associated with targets shown by target element words which are associated with action icons which conceptually indicate the actions of functions specified by entry words and target element words, and the entry word extract section may extract action element words which are associated with selected action icons from the corresponding element word storage section, extract entry words which are associated with all extracted element words from the entry word storage section, and display extracted entry words when an action icon is selected.

According to a second aspect of the present invention, an article including: a storage medium having a plurality of machine readable instructions executed on a problem solution support apparatus for supporting problem solutions for electronic device users based on user input on how to use the device, wherein when the instructions are executed by a machine, cause the problem solution support apparatus to perform functions including: a related icon storage function which stores a plurality of icons, which are images with appearance conceptually associated with at least a part of an entry word, in association with the entry word which specifies problem solving functions of the electronic device; a candidate icon display function which displays at a part of plurality of icons that are candidates for accepting selections from outside on a screen; and an entry word extract function which refers to the related icon storage section to extract the entry word and display the extracted entry word based on combinations of two or more icons when the two or more icons are selected from the icons on the screen displayed by the candidate icon display section. The candidate icon display function divides the plurality of icons into two or more groups and displays them.

The summary of the invention does not necessarily describe all the necessary features of the present invention. The present invention may also be a sub-combinations of the features described above.

### BRIEF DESCRIPTION OF THE DRAWINGS

FIG. 1 is an outline figure indicating the configuration of the portable phone 10 in the present embodiments.

FIG. 2 is an explanatory block figure indicating the functional configuration of the problem solution support apparatus 100.

FIG. 3 is a first example of the data format of the corresponding element word storage section 124.

FIG. 4 is a first example of the data format of the entry word storage section 122.

FIG. 5 is a flowchart illustrating the first example of how the problem solution support apparatus 100 works.

FIG. 6 is a first example illustrating an icon display on the screen 20.

FIG. 7 is an example of an entry word display on the screen 20.

FIG. 8 is an example illustrating Step 112 of FIG. 5.

FIG. 9 is a flowchart illustrating another example of how the entry word extract section 130 works.

FIG. 10 is a second example of the data format of the entry word storage section 122.

FIG. 11 is a second example of the data format of the corresponding element word storage section 124.

FIG. 12 is a third example of the data format of the entry word storage section 122.

FIG. 13 is a flowchart illustrating the second example of how the problem solution support apparatus 100 works.

FIG. 14 is a first diagram of the display example of the screen 20 when the problem solution support apparatus 100 is operated with the procedure explained in FIG. 13.

FIG. 15 is a second diagram of the display example of the screen 20 when the problem solution support apparatus 100 is operated with the procedure explained in FIG. 13.

FIG. 16 is a second diagram of the display example of the screen 20 in which the display area is changed according to the number of next candidate icons.

### DETAILED DESCRIPTION OF THE INVENTION

The invention will not be described based on the preferred embodiments, which do not intend to limit the present invention, but exemplify the invention. All of the features and the combinations thereof described in the embodiment are not necessarily essential to the invention.

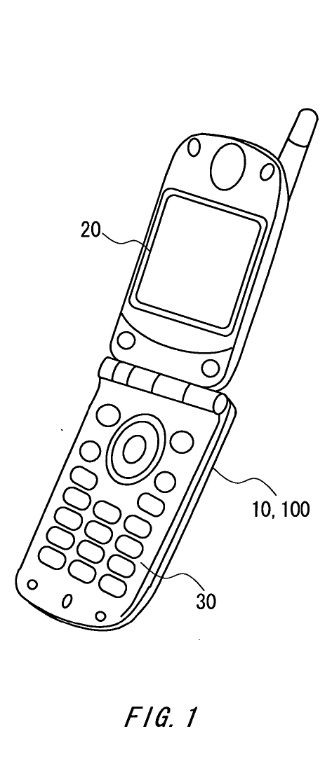

FIG. 1 shows the configuration of the portable phone 10, an example configuration of problem solution support apparatus 100. The problem solution support apparatus 100 is incorporated in an electronic device 10, such as the portable phone 10, and solves problems occurring in such an electronic device. Also, the problem solution support apparatus 100 can be a remote controller for an information home appliance, such as a TV. The problem solution support apparatus 100 includes the screen 20 and the input section 30. The input section 30 has operation keys, such as a select key, for user input.

Conventionally, as for the portable phone 10, icons corresponding to each function and icons corresponding to the upper concepts of each function are hierarchically displayed. In this case, icons corresponding to the upper concepts of a function to be executed are displayed on the screen 20. When the user selects one of the displayed icons, lower hierarchy icons are displayed on the screen 20. However, the icon hierarchy is preset by the electronic device manufacturers. Therefore, unless users understand the hierarchy preset by the manufacturers it is difficult for them to find the desired functions.

The object of the invention of the problem solution support apparatus 100 is to enable the user of a portable phone 10 to promptly select the function that he/she desires and then to execute it.

The problem solution support apparatus 100 supports problem solutions for users of a portable phone 10 based on user input on how to use the device. The screen 20 displays icons with appearances conceptually related to the functions of a portable phone 10. The screen 20 also displays a cursor which circles one of the icons displayed on the screen 20, as well as one or more icons which have been selected by the user. The input section 30 accepts user input.

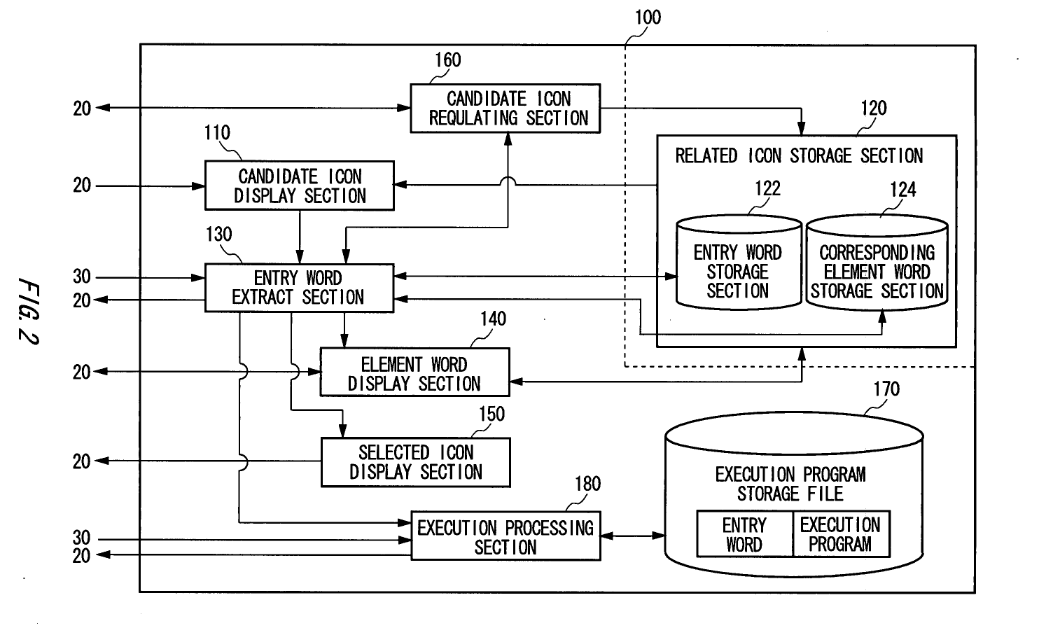

FIG. 2 shows the function configuration of the problem solution support apparatus 100. The problem solution support apparatus 100 includes a candidate icon display section 110, a related icon storage section 120, an entry word extract section 130, an element word storage section 140, a selected icon display section 150, a candidate icon regulating section 160, an execution program storage file 170, and an execution processing section 180.

The related icon storage section 120 stores a plurality of icons, which are images with appearance conceptually associated with at least a part of entry word in association with the entry word which specifies the problem solving functions of a portable phone 10. The related icon storage section 120 includes the entry word storage section 122 and the corresponding element word storage section 124. The related icon storage section 120 can be a database outside of the portable phone 10. In this case, the problem solution support apparatus 100 receives information stored in the related icon storage section 120 using the communications functions of the portable phone 10. The related icon storage section 120 can be included in a recording medium which can be removed from the portable phone 10.

The entry word storage section 122 stores element words which correspond to an entry word and express the concepts of the functions of the entry word. The entry word storage section 122 stores entry words which specify the functions of a portable phone 10 which are for solving user issues concerning how to use the portable phone 10. The functions of the portable phone 10 include the operations and objects for executing the functions. With a portable phone 10 there are cases in which the object for the operation of a function is used as an object for the operations of other functions. With a portable phone 10 there are cases in which the object for the operation of a function is used as an object for the operations of other functions. For example, with the functions ‘Display last phone call charge’ and ‘Delete history of calls sent/received’ of a portable phone 10, the operations ‘Display last phone call charge’ and ‘Delete history of calls sent/received’ are carried out for the same history. In this case, the functions ‘Display last phone call charge’ and ‘Delete history of calls sent/received’ can be considered to belong to the common concept ‘History’. In other words, the entry word storage section 122 stores the operations or words expressing objects which are common to the functions of a portable phone 10 as element words indicating the concepts which belong to the functions indicating the entry words. The entry word storage section 122 may also store identification codes which are allocated to each word instead of words as character strings.

The corresponding element word storage section 124 stores icons with a related conceptual appearance to the element word for each of the element words. The corresponding element word storage section 124 in the present embodiment connects concepts which element words express to icons. The corresponding element word storage section 124 stores images with appearances (icons9 which allow users to associate with concepts which the element words indicate. For example, the corresponding element word storage section 124 stores an image of an envelope which allows users to associate concepts related to mail, such as ‘Send/receive mail’, ‘Read’, and ‘Create new message’. The corresponding element word storage section 124 stores at least a plurality of icons corresponding to an element word and at least a plurality of element words corresponding to one icon.

The candidate icon display section 110 displays on the same screen 20 at least some icons that are candidates for accepting selections from outside. When a user uses a portable phone 10 and selects the ‘Select icon’ function mode the candidate icon display section 110 displays an icon stored in the corresponding element word storage section 124 on the screen 20 as a candidate icon accepting the user‘s selection. The candidate icon display section 110 displays icons on the screen from the top in the order of high frequency of use by the user to low frequency of use. Furthermore, when there are more icons stored in the corresponding element word storage section 124 than the number of icons which can be displayed within the frame of the screen 20 the candidate icon display section 110 displays icons on the screen 20 in the order of he frequency.

The entry word extract section 130 refers to the related icon storage section 120 to extract entry words and display extracted entry words based on combinations of two or more icons when the two or more icons are selected from icons on the screen 20 displayed by the candidate icon display section 110. The entry word extract section 130 according to the present embodiment refers to the corresponding element word storage section 124 to extract element words corresponding to each of the icons when two or more icons are selected. Furthermore, the entry word extract section 130 refers to the entry word storage section 122 to extract entry words corresponding to at least two element words from the entry word storage section 122 and displays the extracted entry words. The entry word extract section 130 requests the input of the decided search after two or more icons are selected from among the icons on the screen 20 displayed by the candidate icon display section 110, and triggered by the input, the entry words are displayed. According to the present embodiment, the entry word extract section 130 requests the input of the decision command for search even when there is only one selected icon and extracts the entry words.

According to the above-mentioned embodiment, when a plurality of icons are selected the entry word extract section 130 extracts entry words corresponding to at least two element words which are extracted from the corresponding element word storage section 124 from the entry word storage section 122 and displays them. However, the extraction and display methods of the entry word extract section 130 are not necessarily the same as one another. For example, the entry word extract section 130 may extract the most numerous entry words corresponding to element words which are extracted from the corresponding element word storage section 124. Another example is that the entry word extract section 130 may extract entry words corresponding to element words which are extracted from the corresponding element word storage section 124 and may give priority to entry words corresponding to the most numerous element words for display.

In order to solve the problems of a user of a portable phone 10 concerning how to use the phone the user selects from the screen 20 icons which are associated with the functions of the phone 10 that the user wants to use. The user moves the cursor on the screen 20 to select an icon and presses the select key on the input section 30 to set the selection. The entry word extract section 130 displays the ‘Search’ button on the screen 20. When the user wants to conduct a search of entry words based on the selected icon he/she presses the Select key in the input section 30 by highlighting the ‘Search’ button and inputs the decided search.

When an icon is selected the entry word extract section 130 extracts all the element words corresponding to the selected icon which are stored in the corresponding element word storage section 124. The entry word extract section 130 extracts all the entry words corresponding to the element words extracted from the corresponding element word storage section 124 from the entry word storage section 122. Then, when the second icon is selected the entry word extract section 130 extracts entry words corresponding to the second icon using the same procedure. The entry word extract section 130 compares the extracted entry words which correspond to the first icon and the extracted entry words which correspond to the second icon and extracts matching entry words.

When the third icon is selected the entry word extract section 130 also compares the extracted entry words which correspond to the first icon, the extracted entry words which correspond to the second icon, and the extracted entry words which correspond to the third icon and extracts matching entry words. The entry word extract section 130 displays extracted entry words on the screen 20 when the decided search is input.

According to the above-mentioned embodiment, the entry word extract section 130 displays extracted entry words on the screen 20 when the decided search is input. However, there are other cases in which the entry word extract section 130 displays extracted entry words on the screen 20. For example, the entry word extract section 130 may display entry words on the screen 20 when the number of extracted entry words is a predetermined number or fewer. In this case, the entry word extract section 130 displays entry words on the screen 20 when the number of entry words which can be displayed within the frame of the screen 20 is a predetermined number or fewer. When an icon is selected the entry word extract section 130 compares the number of extracted entry words with that of the entry words which can be displayed on the screen 20. When the number of extracted entry words is no greater than the number of entry words which can be displayed on the screen 20 the entry word extract section 130 displays the extracted entry words on the screen 20. With this feature there are no entry words which cannot be seen without scrolling which greatly enhances operability.

The element word storage section 140 displays element words corresponding to tentatively selected icons on the screen. The user uses operation keys on the input section 30 to circle an icon displayed on the screen 20. The element word storage section 140 regards the icon to be tentatively selected when it remains circled with the cursor for at least one second. The element word storage section 140 in the present embodiment displays a bubble area for tentatively selected icons and displays element words which correspond to a tentatively selected icon to be stored in the corresponding element word storage section 124. The element word storage section 140 displays element words in the bubble area for a predetermined time (only two seconds, for example) after an icon is tentatively selected. With this feature element words corresponding to an icon can be shown to the user and the user can select a correct icon.

The selected icon display section 150 displays two or more selected icons on the same screen. The selected icon display section 150 in the present embodiment moves a selected icon on the screen 20 to a different area from the one where the candidate icon which accepts the selection is displayed and displays it as a selected icon. When there is only one selected icon the selected icon display section 150 displays the icon as a selected icon. With this feature the user can confirm the icon which he/she has selected.

The candidate icon regulating section 160 refers to the related icon storage section 120 to extract other icons which correspond to entry words corresponding to selected icons and receives the selection of other extracted icons when an icon is selected from icons on the same screen displayed by the candidate icon display section 110. The candidate icon regulating section 160 in the present embodiment accepts selections of other icons by displaying icons other than the extracted ones stored in the related icon storage section 120. In other words, the candidate icon regulating section 160 extracts other icons corresponding to the same entry words stored in the related icon storage section 120 as highly connected icons. Furthermore, the candidate icon regulating section 160 displays only extracted icons on the screen 20 where the candidate icons are displayed. The candidate icon regulating section 160 distinguishes extracted icons from other icons stored in the related icon storage section 120. The icons which can be selected may be displayed in gray on the screen 20.

The execution program storage file 170 stores execution programs for executing problem solving functions which correspond to entry words specifying the functions of a portable phone 10. The execution program storage file 170 stores execution programs for executing problem solving functions which correspond to entry words specifying the functions of a portable phone 10 which are for solving problems of users about how to use the phone.

The execution processing section 180 refers to the execution program group storage file to execute an execution program corresponding to predetermined entry words when an execution command for a displayed entry word is input. The user selects entry words specifying the functions of a portable phone 10 which he/she wants to use from entry words displayed on the screen 20. The user inputs an execution command by pressing the Select key on the input section 30 after selecting entry words on the screen 20. The execution processing section 180 reads and executes an execution program stored in the execution program storage file 170 when an execution command is input.

With the configurations described above, the problem solution support apparatus 100 efficiently extracts the problem solving functions of a user about how to use a portable phone 10 based on user input and allows prompt execution of the program of the extracted program.

The execution program storage file 170 stores a program which causes the problem solution support apparatus 100 to implement the functions of the candidate icon display section 110, related icon storage section 120, entry word extract section 130, element word storage section 140, selected icon display section 150, candidate icon regulating section 160, and execution processing section 180. The execution program storage file 170 may obtain such programs through a network, such as the Internet.

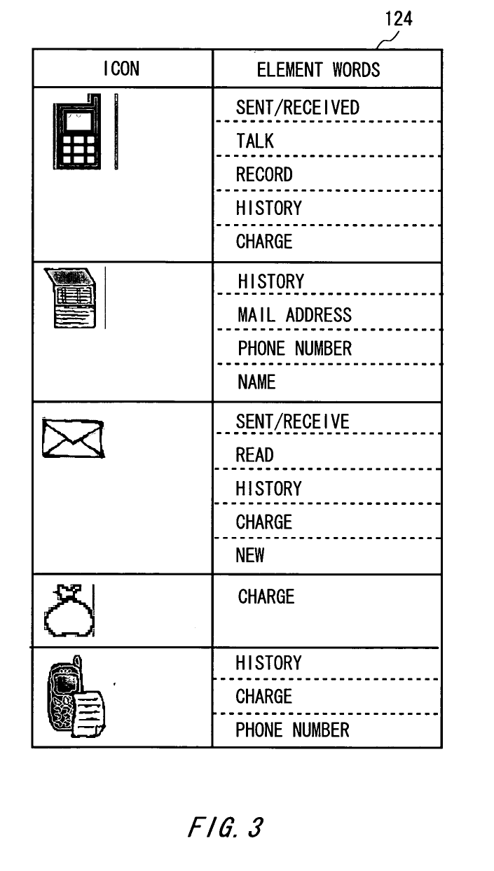

FIG. 3 shows an example of the data format of the corresponding element word storage section 124. The corresponding element word storage section 124 stores icons with a related conceptual appearance to the element word for each element word. For example, the corresponding element word storage section 124 stores ‘Send/receive’, ‘Talk’, ‘Record’, ‘History’, and ‘Charge’ as element words which correspond to the icon ‘Telephone’. With the example shown in FIG. 3, the corresponding element word storage section 124 stores images of the icons. Alternatively, the problem solution support apparatus 100 includes the icon storage section in which images of the icons correspond to icon identifying information for identifying icons. The corresponding element word storage section 124 may store icon identifying information for identifying icons.

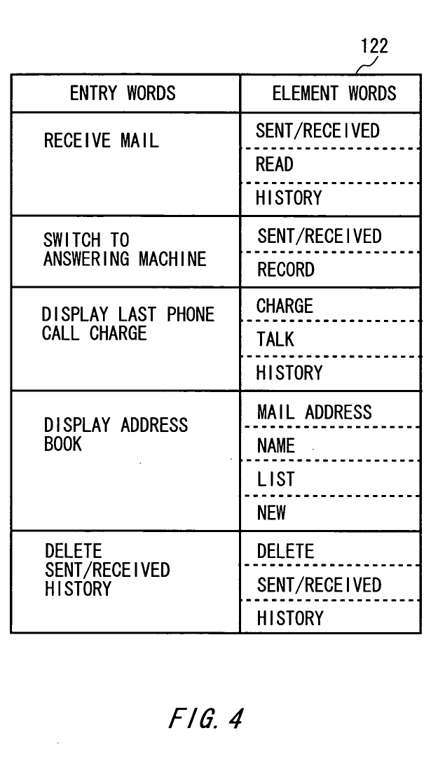

FIG. 4 shows an example of the data format of the entry word storage section 122. The entry word storage section 122 stores element words indicating the concepts of the functions of entry words. For example, the entry word storage section 122 stores ‘Send/receive mail’, ‘Read’, and ‘History’ as element words which correspond to the entry word ‘Receive mail’.

As explained above, the entry word storage section 122 and the corresponding element word storage section 124 connect entry words specifying the functions of a portable phone 10 and the icons conceptually related to entry words using element words. The problem solution support apparatus accepts the input of character strings, extracts element words contained in the character strings, and refers to the entry word storage section 122 to specify the extracted entry words with the entry word extract section 130. According to the present embodiment, the entry word storage section 122 and the entry word extract section 130 can be shared in a problem solution support system by connecting entry words and icons using element words. Furthermore, database development is easier for a database developer compared to situations where icons and entry words are connected by allocating identification codes because the appearances of icons and element words are conceptually connected.

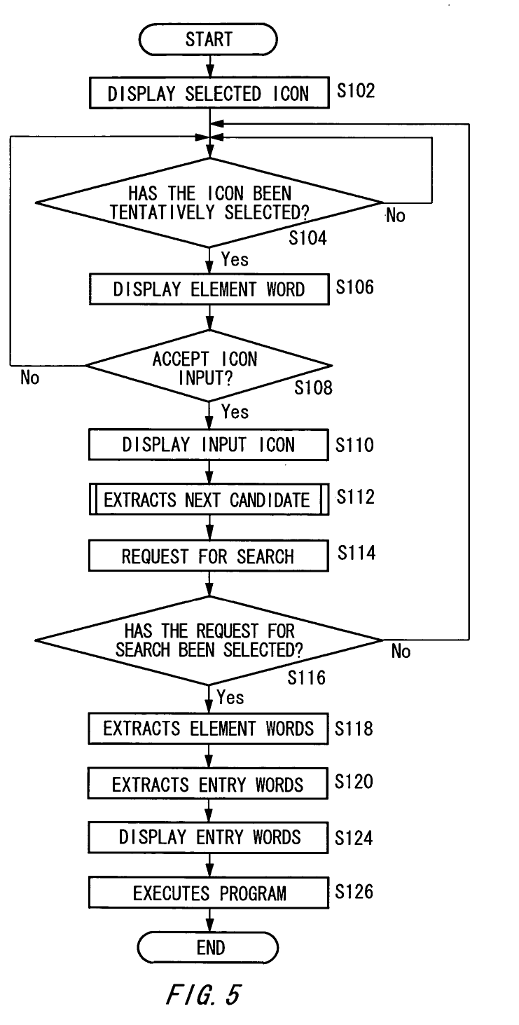

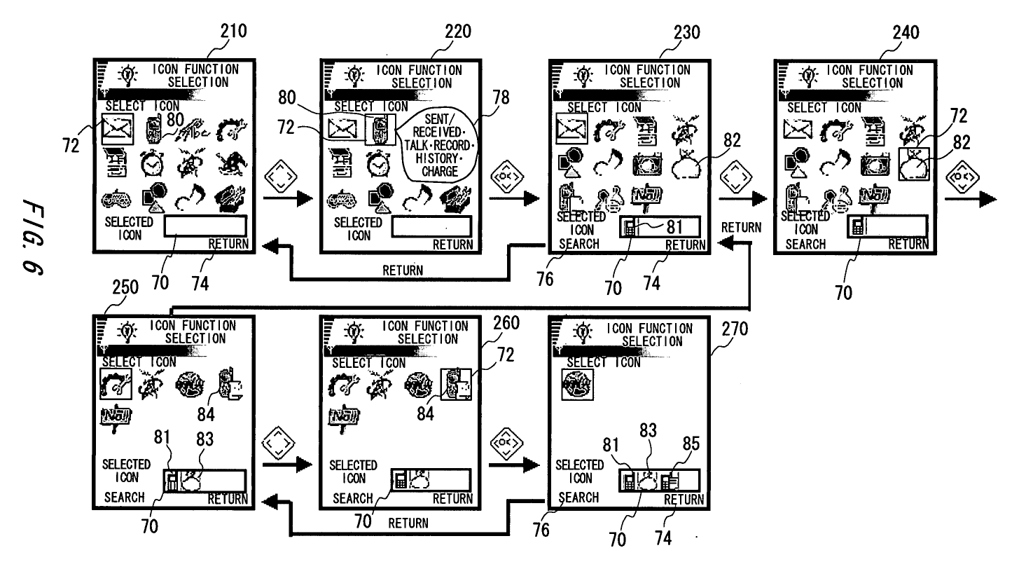

FIG. 5 shows a flowchart illustrating an example of how the problem solution support apparatus 100 works. FIG. 6 shows the screen in a situation where icons are selected to execute the function for displaying the telephone charge for the last call. Below is an explanation of the flowchart of FIG. 5 using an example of a situation where icons are selected to execute the functions for displaying the telephone charge of the last call which is described in FIG. 6.

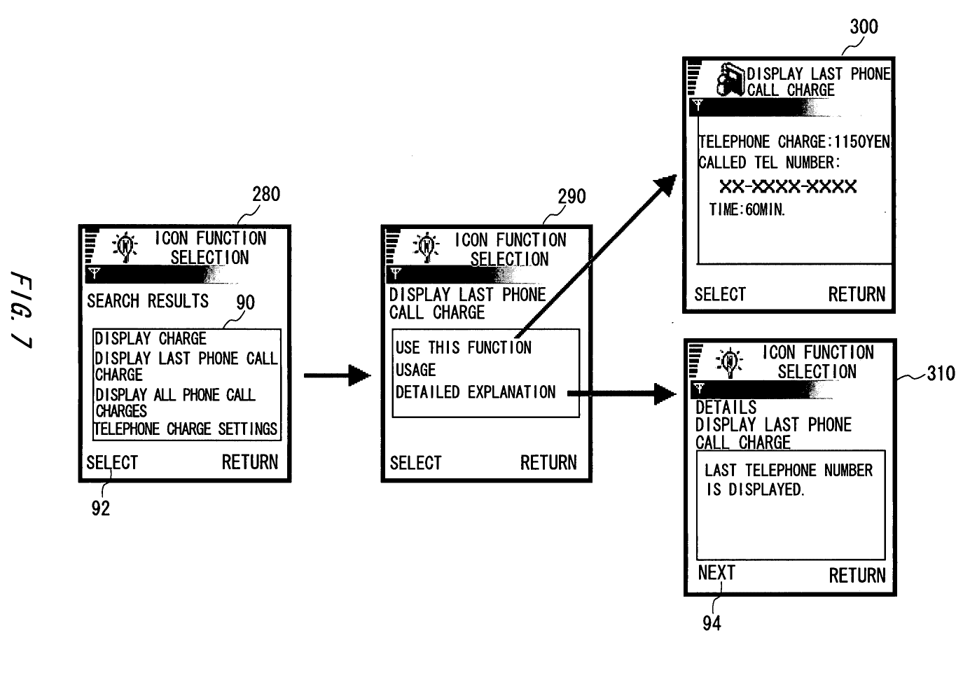

When the user selects the icon function select mode on the initial screen where he/she can select a mode from the display mode of the function names list, the display mode of the history list, and the icon function select mode, the candidate icon display section 110 displays the icons stored in the corresponding element word storage section 124 from the upper side of a first screen 210 in the order of the frequency of the user (S102). The first screen 210 displays a cursor 72 on the icon located in the upper left of the screen. On each screen of the first screen 210 to a seventh screen 270 shown in FIG. 7, a selected icon display frame 70 is displayed on, for example, the lower part of the screen as an area for displaying a selected icon, and a ‘Return’ button 74 is displayed at the lower right on the screen for returning to a previous screen form the current screen.

The element word storage section 140 judges whether the cursor 72 circled the icon for a sufficient length of time when a candidate icon for accepting the user selection is displayed on the screen. In other words, the element word storage section 140 judges whether the icon has been tentatively selected (S104). When the icon has not been tentatively selected (S104: No) the operation of the problem solution support apparatus 100 returns to step 104. When a telephone icon 80 associated with the function of the telephone charge display is tentatively selected (S104: Yes), as shown in the second screen 220 in FIG. 6, the element word storage section 140 displays a bubble area for the telephone icon which has been tentatively selected and displays the element words ‘Send/receive’, ‘Talk’, ‘Record’, ‘History’, and ‘Charge’ stored in the corresponding element word storage section 124 which correspond to the tentatively selected telephone icon in the displayed bubble area 78 (S106).

After the telephone icon 80 is tentatively selected the selected icon display section 150 judges whether the telephone icon 80 has been selected by whether or not the select key on the input section 30 has been pressed (S108). When the telephone icon 80 is selected (S108: Yes), as shown in the third screen 230, the selected icon display section 150 moves the telephone icon 80 to the inside of the selected icon display frame 70 and displays it as selected telephone icon 81 (S110). When the telephone icon 80 is not selected (S108: No) the operation of the problem solution support apparatus 100 returns to step 104. The candidate icon regulating section 160 selects an icon which is closely connected with the selected telephone icon 80 as the next candidate icon (S112) and displays it on the third screen 230. How step 112 is carried out is explained below. When the telephone icon 80 is selected the entry word extract section 130 displays the ‘Search’ button 76, for example, on the bottom left of the third screen 230 as a request for the selection of search decision.

The entry word extract section 130 judges whether the select key of the input section 30 has been pressed, or, in other words whether the search decision has been made (S116), while the ‘Search’ button 76 displayed on the third screen 230 is highlighted. When the search decision is not made (S116: No) the operation of the problem solution support apparatus 100 returns to step 104. When the ‘search’ decision is made (input) (S116: Yes) the entry word extract section 130 extracts all the element words stored in the corresponding element word storage section 124 which corresponds to the selected telephone icon 80. The entry word extract section 130 extracts entry words which correspond to the element words extracted from the corresponding element word storage section 124 from the entry word storage section 122. The entry word extract section 130 displays the extracted entry words on the screen (S124). When the select key on the input section is pressed while the ‘Return’ button is switched to turn over indication on the third screen 230 the problem solution support apparatus 100 once again displays the first screen 210, on which all the candidate icons are displayed.

Below is an explanation of the screen at the time the money icon 82 and the send/receive mail history icon 84 are selected after the telephone icon 80 has been selected. The fourth screen 240 to seventh screen 270 are explained as shown in FIG. 6. The fourth screen 240 shows the money icon 82 which is tentatively selected as an icon associated with the telephone charge display function. When the money icon 82 is tentatively selected and then is selected, as shown in the fifth screen 250, the selected icon display section 150 moves the money icon 82 to the inside of the selected icon display frame 70 and displays it as the selected money icon 83. The candidate icon regulating section 160 extracts icons which are closely related to the selected telephone icon 80 and the money icon 82 as the next candidate icon and displays them on the fifth screen 250.

Then the sixth screen 260 shows the send/receive mail history icon 84 tentatively selected as an icon associated with the telephone charge display function. When the send/receive mail history icon 84 is tentatively selected and the send/receive mail history icon 84 is selected the selected icon display section 150 moves the send/receive mail history icon 84 to the inside of the selected icon display frame 70 and displays it as the selected send/receive mail history icon 85 on the seventh screen 270. The candidate icon regulating section 160 extracts icons which are closely related to the selected telephone icon 80, the money icon 82, and the send/receive mail history icon 84 as the next candidate icons and displays them on the seventh screen 270.

In step 116, when the search decision is made (input) (S116: Yes) the entry word extract section 130 extracts entry words based on the selected icons (S118, S120). In the present embodiment, when more than one icon is selected the entry word extract section 130 extracts all the element words stored in the corresponding element word storage section 124 which correspond to the selected icons. In addition, the entry word extract section 130 extracts entry words which correspond to at least two extracted element words.

When the telephone icon 80, the money icon 82, and the send/receive mail history icon 84 are selected the entry word extract section 130 extracts element words corresponding to these icons. In the example shown in FIG. 3, the entry word extract section 130 extracts ‘Send/receive mail’, ‘Talk’, ‘Record’, ‘History’, and ‘Charge’ as element words which correspond to the telephone icon 80. Other icons are treated in the same way. Then, the entry word extract section 130 compares the extracted entry words which correspond to the element words of the telephone icon 80, the extracted entry words which correspond to the element words of the money icon 82, and the element words of the send/receive mail history icon 84, and extracts entry words which correspond to the element words of at least two icons. With the example shown in FIG. 4, the ‘Display last telephone charge’ corresponding with ‘Talk, History, and Charge’ (element words of the telephone icon 80), ‘Charge’ (element word of the money icon 82), and ‘History and charge’ (element words of send/receive mail history icon) is extracted as an entry word. The entry word extract section 130 displays the extracted entry words on the screen (S124).

Below is an explanation of the flowchart shown in FIG. 5 using the screen when the ‘Display last telephone charge’ function is executed. The entry word extract section 130 displays ‘Display charge unit’, ‘Display last telephone charge’, ‘Display all telephone charge’, and ‘Set telephone charge’ in the entry word display frame 90 of the eighth screen 280 when the search decision is made input. The eighth screen 280 displays the ‘Select’ button 92 on the bottom left of the screen, which is for accepting the user's selection of an entry word. On the eighth screen 280 when the select key on the input section 30 is pressed while the ‘Display last telephone charge’ and ‘Select’ buttons are switched to turn over indication the entry word extract section 130 displays ‘Use this function’, ‘Display usage method’, and ‘Display detailed explanation’ on the ninth screen 290 for ‘Display last telephone charge’.

Then, when the select key on the input section 30 is pressed while the ‘Use this function’ button and the ‘Select’ button 92 are highlighted on the ninth screen 290, in other words when the command to execute a function specified by a selected entry word is input, the execution processing section 180 reads out the execution program stored in the execution program storage file 170 which corresponds to the entry word ‘Display last telephone call’ The execution processing section 180 executes the execution program which has been read out (S126) and displays ‘Telephone charge: ¥1, 150, Called tel number: xx-xxxx-xxxx, Time: 60 min.’ on the tenth screen 300. When the Select key on the input section 30 is pressed while the ‘Display detailed explanation’ button and the ‘Select’ button 92 are highlighted on the ninth screen 290 the execution processing section 180 displays ‘Last telephone charge is displayed’, which is a detailed explanation for the entry word ‘Display last telephone call’ on the eleventh screen 310. The ‘Next’ button for displaying the ongoing detailed explanation is displayed at the bottom left of the eleventh screen 310. The flowchart is ended hereinbefore.

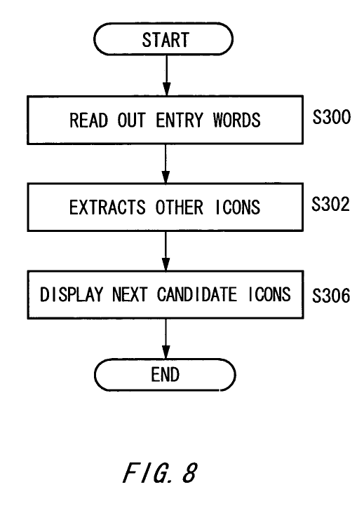

FIG. 8 shows a flowchart indicating how step 112 of FIG. 5 works. The candidate icon regulating section 160 extracts all the element words corresponding to the selected icon stored in the corresponding element word storage section 124. The candidate icon regulating section 160 reads out the entry words corresponding to the element word extracted from the corresponding element word storage section 124 from the entry word storage section 122 (S300). The candidate icon regulating section 160 extracts element words to be stored in the entry word storage section 122 corresponding to the read out entry words. The selected icon display section 150 extracts icons to be stored in the corresponding element word storage section 124 corresponding to the extracted element words as other icons corresponding to the selected icons (S302). The candidate icon regulating section 160 displays extracted icons as candidate icons which accept the next selection on the screen (S306).

The candidate icon regulating section 160 does not display icons with which an entry word is not extracted based on the icons to be selected and pre-selected icons as candidates to be selected next. Therefore, the candidate icon regulating section 160 displays on the screen the icon which is the next candidate so that situations in which there are no entry words corresponding to the icons selected by the user can be prevented.

As explained above, the problem solution support apparatus 100 allows the user of a portable phone 10 to promptly conduct a search for a desired function simply by selecting icons related to the functions of the portable phone 10.

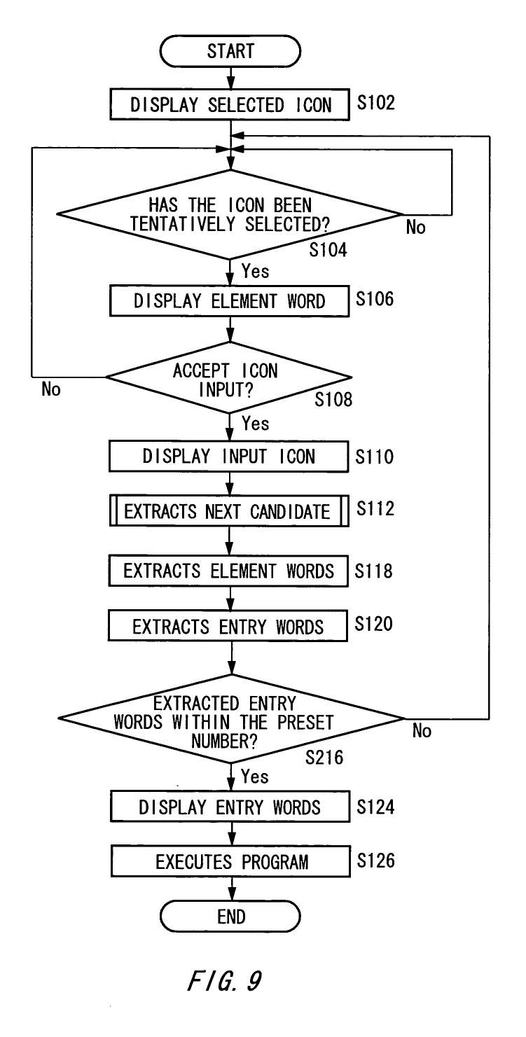

FIG. 9 shows a flowchart providing another example of how the problem solution support apparatus 100 works. In FIGS. 5 and 9 steps bearing the same reference numbers work the same in the problem solution support apparatus 100. Therefore, steps with the same reference numbers are not explained. When an icon is selected the entry word extract section 130 judges whether the number of extracted entry words exceeds the number of entry words that can be displayed within the entry word display frame 90 on the eighth screen 280 (S216). When the number of extracted entry words does not exceed the number of entry words that can be displayed within the entry word display frame 90 (S216: Yes) the entry word extract section 130 displays the extracted entry words (S124). When the number of extracted entry words is no fewer than that of entry words that can be displayed within the entry word display frame 90 (S216: No) the operation of the problem solution support apparatus 100 returns to step 104. For example, as shown in FIG. 7, since the eighth screen 280 can display four entry words within the entry word display frame 90, the entry word extract section 130 displays the extracted entry words when the number of extracted entry words corresponding to the selected icons is four or fewer. As explained above, the problem solution support apparatus 100 can automatically display extracted entry words when the number of icons displayed on the screen is low.

As explained above, the problem solution support apparatus 100 efficiently extracts user problem solution functions about how to use a portable phone 10 based on user input and enables prompt execution of the program of the extracted program. Since the problem solution support apparatus 100 extracts entry words based on one or more icons selected by the user the order of the selection of icons by the user does not affect the process. Therefore, the function search of the problem solution support apparatus 100 is different from that of a device with a conventional hierarchical configuration and it allows the user to easily reach functions desired.

According to the embodiments shown in FIGS. 1 to 9, the problem solution support apparatus 100 has an entry word storage section 122 and a corresponding element word storage section 124, and it connects the entry words specifying the functions of the portable phone 10 and the icons conceptually related to the entry words using element words. However, there is not only one type of connection between entry words and icons. The entry word storage section 122 can also store entry words and icons which are conceptually connected to the entry words. In this case, the entry word extract section 130 of the problem solution support apparatus 100 refers to the entry word storage section 122 based on the icon selected by the user and directly displays the entry words without using element words. With this process the corresponding element word storage section 124 is not necessary and the database capacity of the problem solution support apparatus 100 is reduced.

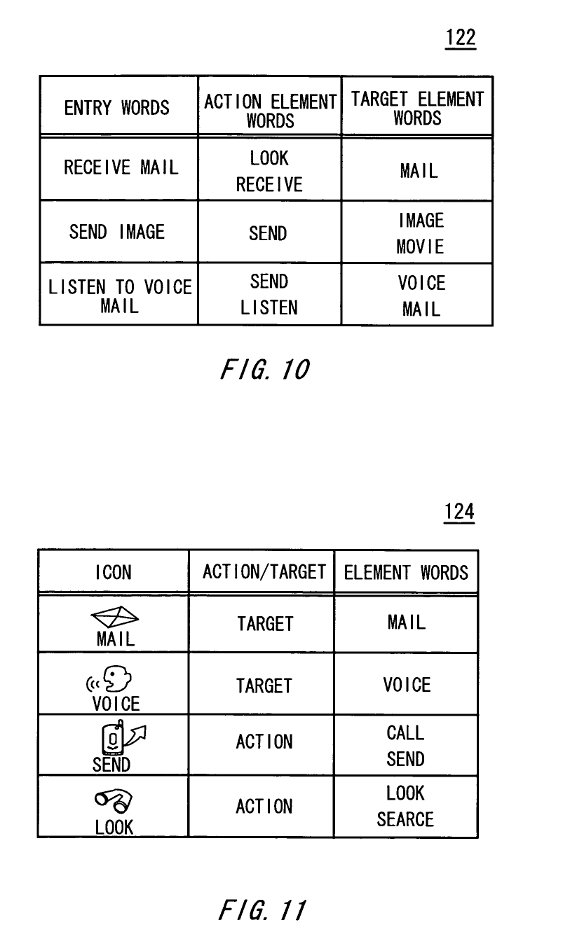

FIG. 10 shows the second example of the data format of the entry word storage section 122. The entry word storage section 122 in the invention associates element words (action element words) which conceptually indicate the actions of the functions specified by entry words and element words (target element words) which conceptually indicate the targets of the functions specified by entry words with entry words, and stores them. A plurality of action element words and target element words may be associated with an entry word. With the entry word storage section 122 in the invention, functions specified by entry words can be accurately expressed by classifying element words corresponding to entry words into action element words or target element words and by combining them. Therefore, the number of entry words corresponding to entry words can be minimized.

FIG. 11 shows the second example of the data format of corresponding element word storage section 124. The corresponding element word storage section 124 of the invention associates action icons indicating the actions which the action elements words indicate with action element words indicating the actions of the functions which the problem solution support apparatus 100 has, and stores them. Further, it associates target icons indicating the targets which the target element words indicate with target element words indicating the targets of the functions which problem solution support apparatus 100 has, and stores them. With the corresponding element word storage section 124 of the invention element words corresponding to each icon can be limited by pre-classifying the meanings of icons into an action or a target. Therefore, the data volume of corresponding element word storage section 124 can be minimized. For example, the data volume of the corresponding element word storage section 124 can be smaller than that shown in the first example in FIG. 3.

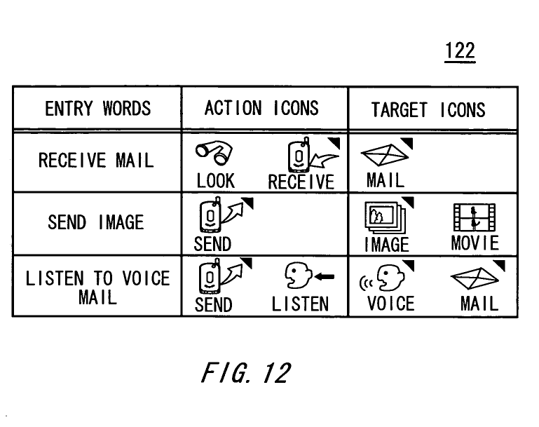

FIG. 12 shows the third example of the data format of the entry word storage section 122. The entry word storage section of the invention distinguishes an action icon and a target icon, associates them with entry words, and stores them. With the entry word storage section 122 of the invention, the functions indicated by each entry word can be accurately expressed by classifying the icons corresponding to the entry words into an action icon or a target icon and by combining them. Therefore, the number of icons corresponding to entry words can be minimized.

The data format of the entry word storage section 122 and the corresponding element word storage section 124 is not limited to the examples shown in FIGS. 10, 11, and 12. For example, the database for the corresponding element word storage section 124 may be divided into an action or a target for icons and element words. Thus, embodiments with such modifications to the entry word storage section 122 and the corresponding element word storage section 124 also belong to the scope of the present invention.

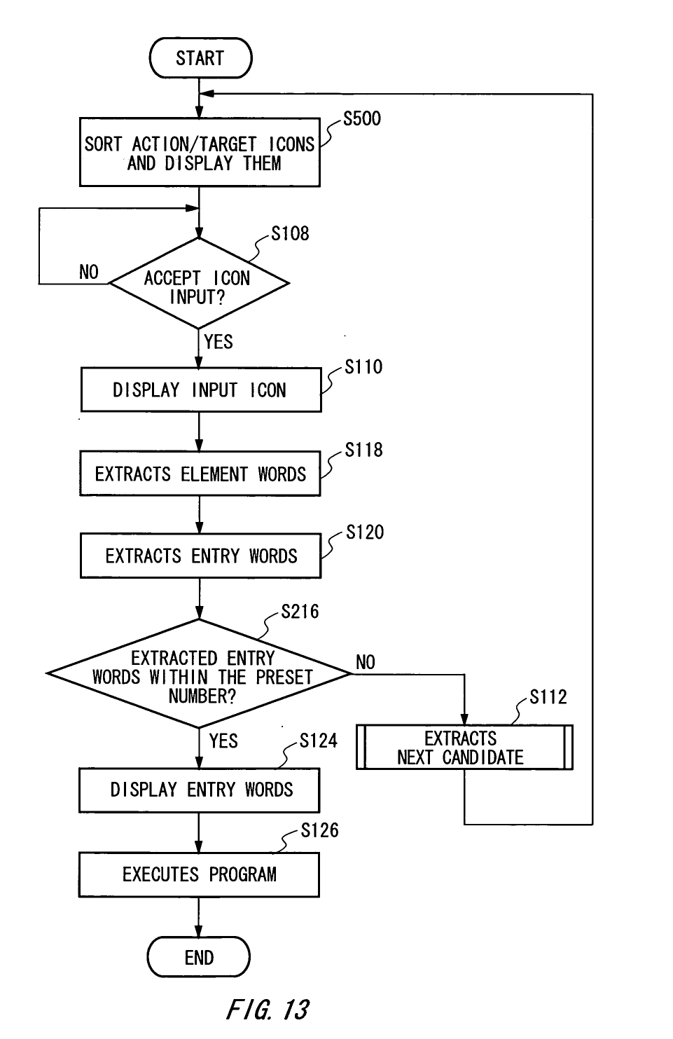

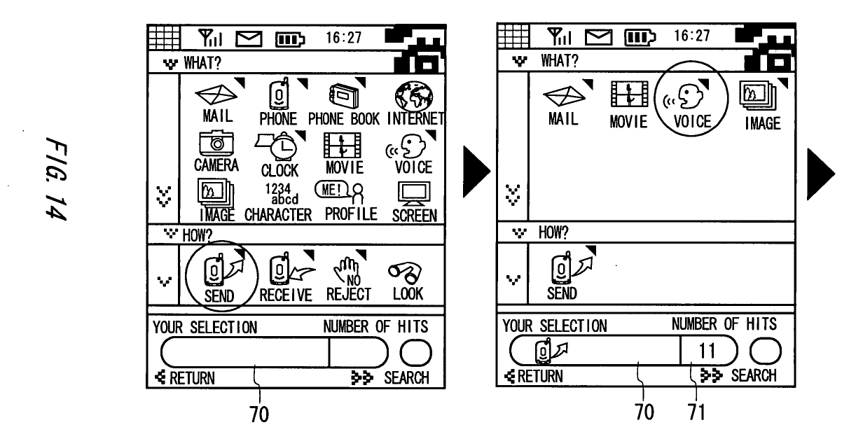

FIG. 13 shows a flowchart providing another example of how the problem solution support apparatus 100 works. FIGS. 14, 15, and 16 show examples of the screen 20 when the problem solution support apparatus 100 works with the procedures shown in FIG. 13. In the present example, the entry word storage section 122 and the corresponding element word storage section 124 have the configuration of the second example explained in FIGS. 10 and 11. The flowchart shown in FIG. 13 is explained with FIGS. 14, 15, and 16 below. In FIGS. 5 and 9 steps bearing the same reference numbers work the same in the problem solution support apparatus 100. Therefore, steps with the same reference numbers are not explained.

The candidate icon display section 110 divides a plurality of icons stored in the related icon storage section 120 into two or more groups and displays them. For example, the first group of two or more groups is displayed as an action icon group in one window and the second group as a target icon group in a different window (S500). FIG. 14 shows an example of displaying two or more groups as action icons and target icons. In the figure the target icons are displayed in the ‘What’ window on the top of the screen and the action icons are displayed in the ‘How’ window at the bottom of the screen. When there is an icon which cannot be displayed on a window, a scroll button appears on the left or right side of the window. The icon displayed on the window scrolls when the scroll button is selected and other icons are displayed.

In the figure the icons with a triangle on the top right are called ‘direct icons’ and priority is given to entry words with high usage frequency. The functions assigned to direct icons can be directly executed through operations such as double clicking on a direct icon. For example, the target icon ‘mail’ on the top left of the ‘What’ window corresponds to ‘create mail’, which is given the highest priority in entry words corresponding to the target icon ‘mail’ as a function of a direct icon with priority.

The positions of the ‘What’ window for displaying target icons and the ‘How’ window for displaying action icons can be switched according to the language the user uses. For example, with Japanese sentences the object comes before the verb. Therefore, a user can select an icon with the Japanese sentence order by arranging target icons and action icons vertically or horizontally with this order. On the other hand, with English sentences the verb usually comes before the object. Therefore, a user can select an icon with the English sentence order by arranging action icons above or on the left of the target icons. As with these languages it is desirable that the action icons and target icons be arranged in the standard sentence order of the language. This enhances operability.

The flowchart in FIG. 13 is explained again. When either an action icon or a target icon is input (S108: Yes) the entry word extract section 130 displays the input icon in the selected icon display frame 70, refers to the corresponding element word storage section 124, and extracts element words corresponding to the input icon (S118). For example, when an action icon displayed in the ‘How’ window is selected the corresponding element word storage section 124 extracts action element words corresponding to the selected icon from the corresponding element word storage section 124. The entry word extract section 130 further refers to the entry word storage section 122 and extracts entry words corresponding to entry words extracted from the corresponding element word storage section 124 (S120).

In Step 108 when an action icon is selected the candidate icon display section 110 may expand the display area for target icons, and when a target icon is selected the candidate icon display section 110 may expand the display area for action icons. In other words, when an icon is selected from one of two or more groups, display areas for other groups may be expanded. With this, many icons which are highly likely to be selected next can be displayed and the desired icons can be easily selected.

When the data format of the entry word storage section 122 is the same as the third example shown in FIG. 12, and when at least one action icon or target icon is selected in Step 108 the entry word extract section 130 extracts entry words directly corresponding to all the icons which have been selected from the entry word storage section 122.

The entry word extract section 130 judges whether the number of extracted entry words exceeds the number of entry words that can be visually recognized easily, for example eight words, within the entry word display frame 90 (S216). When the number of extracted entry words does not exceed the number of entry words that can be visually recognized easily within the entry word display frame 90 (S216: Yes) the entry word extract section 130 displays the extracted entry words (S124). When one of the displayed entry words is selected and the execution command is input, the execution processing section 180 reads out and executes an execution program corresponding to the entry word the execution of which is commanded (S126).

In Step 216 when the number of extracted entry words in the entry word display frame 90 exceeds the number of entry words that can be visually recognized easily (S216: No) the candidate icon regulating section 160 extracts selected icons using element words and entry words or other icons which are directly associated with other icons by referring to the corresponding element word storage section 124 and the entry word storage section 122, divides them into action icons and target icons, and displays them as the next candidate icons on the screen (S500). A display example of the next candidate icons is shown in the second screen of FIG. 14.

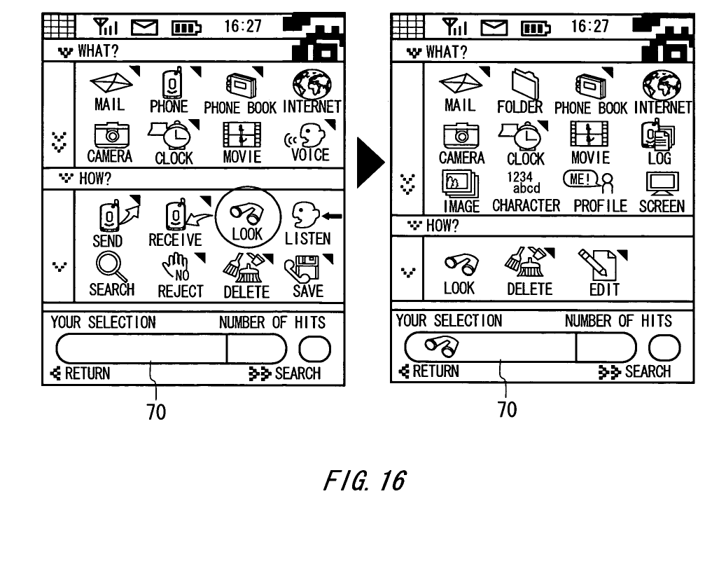

Further, when an icon is selected from one of the two or more groups, the candidate icon regulating section 160 refers to the related icon storage section 120, extracts other icons corresponding to the entry word which corresponds to selected icons, compares the number of extracted icons which are displayed by the candidate icon display section 110 among two or more groups, and may expand the display area of the group which has the greater number of extracted icons. For example, the candidate icon regulating section 160 compares the number of extracted action icons and target icons and may expand the display area of the icons of greater number. Such a screen display example is shown in FIG. 16. When the extract number of either action icons or target icons is 0 the candidate icon regulating section 160 may minimize or close the display area with no extracted icons. In this case, selection of the next icon is made easier by expanding the display area of the other icons.

In the example shown in FIG. 14 the user wishes to dial-up the voice center and execute the stored voice message play function. First, the user selects the action icon ‘send’ which conceptually indicates the action of dialing up the voice center. Then the entry word extract section 130 extracts the element words ‘call’ and ‘send’, indicating actions associated with the action icon ‘send’ in the corresponding element word storage section 124. Further, the entry word extract section 130 searches for entry words which are associated with the element words ‘call’ or ‘send’ in the entry word storage section 122. At this point, the number of entry words which have been hit is displayed in the candidate words number display section 71. For example, in the object of the invention the number of entry words corresponding to the element words ‘call’ or ‘send’ is 11 and the number is displayed in the candidate words number display section 71 (FIG. 14, second screen).

The entry word extract section 130 refers to the entry word storage section 122 shown in FIG. 10 as an example and reads the entry words ‘send image’ or ‘listen to voice mail’, which are associated with the element words ‘call’ or ‘send’. Then the entry word extract section 130 extracts the target element words ‘image’, ‘movie’, ‘voice’, and ‘mail’ and the action element word ‘listen’ as other element words. After that the entry word extract section 130 extracts icons associated with each extracted element word from the corresponding element word storage section 124. As FIG. 14 shows the entry word extract section 130 sorts ‘image’, ‘movie’, ‘voice’, and ‘mail’ icons which have been extracted from the corresponding element word storage section 124 into action icons and target icons and displays them as next candidate icons.

As explained above, the problem solution support apparatus 100 narrows down icons which could be the next selection candidate according to the icon selection of the user, improving operability. Further, the problem solution support apparatus 100 prevents the selection of icons which do not correspond to an entry word. Therefore, search efficiency can be improved.

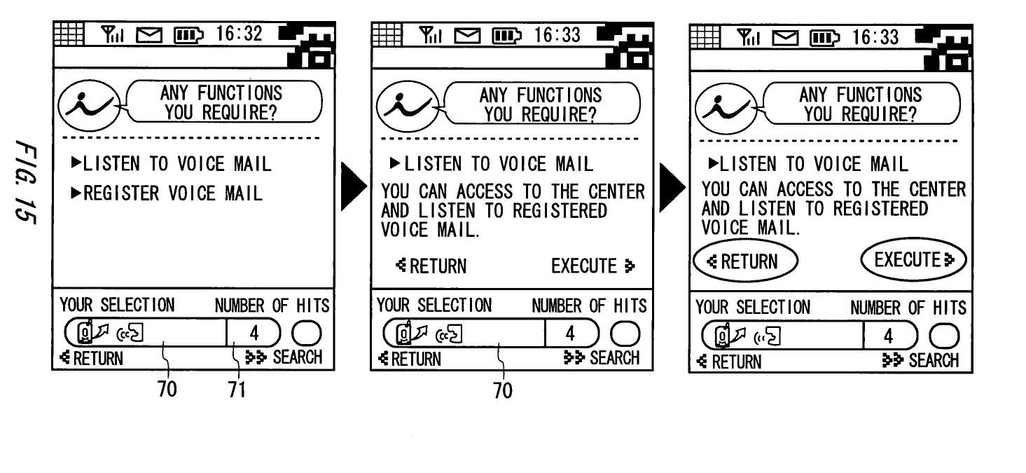

When the action icon ‘send’ and the target icon ‘voice’ are selected the entry word extract section 130 narrows down the corresponding entry words to ‘listen to voice mail’ and ‘register voice mail’ by searching the corresponding element word storage section 124 and entry word storage section 122 in order. The candidate words number display section 71 displays 2 for the number of entry words (FIG. 15). At this point, since the number of entry words can be displayed in the entry word display frame 90 at once the entry word extract section 130 promptly displays entry words ‘listen to voice mail’ and ‘register voice mail’ in the entry word display frame 90. When one of the displayed entry words is selected its function or operation specified by the entry words is explained (FIG. 15, center) and the screen shifts to the execution screen for the function by inputting ‘execute’ and returns to the entry word candidate list screen by inputting ‘return’. The flowchart is ended hereinbefore.

When a plurality of icons is selected at least one action icon and one target icon may be selected or a plurality of icons may be selected from either action icons or target icons. In either case, the entry word extract section 130 extracts entry words which are associated with a plurality of selected icons.

As in the present example, the user can accurately and easily select icons which specify the functions the user desires by sorting action and target icons according to meaning and displaying them in different windows. Therefore, the operability and the search accuracy of the entry word extract section 130 improve. Further, the related icon storage section 120 sorts the meanings of icons corresponding to entry words according to the action and target functions of entry words, accurately showing the functions entry words indicate with a minimum of icons. Therefore, the data volume of the related icon storage section 120 can be reduced. As a result, the cost and the size of the problem solution support apparatus 100 can be reduced.

According to the embodiments shown in FIGS. 1 to 16, the problem solution support apparatus 100 is stored in the portable phone 10 or other electronic device and the portable phone 10 includes the screen 20 and the input section 30. However, the input section 30 can also be arranged in electronic device. The functions of the candidate icon display section 110, the related icon storage section 120, the entry word extract section 130, the element word storage section 140, the selected icon display section 150, the candidate icon regulating section 160, the execution program storage file 170, and the execution processing section 180 of the problem solution support apparatus 100 are stored in an electronic device and the functions of the input section 30 which accept user input for selecting an icon from among the several icons displayed on the selected icon display section 150 and are output to the entry word extract section 130. For example, an electronic device is an information home appliance and the user input device is a remote controller for operating the information home appliance. In this situation, the input section 30 may include a Select key (operation key) which allows the user to input. The input section 30 may also contain a Cursor Command key which shows the location of the cursor displayed on the selected icon display section 150. According to the embodiments a remote controller with a simple configuration can be used as the input section 30 for the problem solution support apparatus 100 of an electronic device.

Although the present invention has been described by the way of an exemplary embodiment, it should be understood that those skilled in the art might make many changes and substitutions without departing from the spirit and the scope of the present invention. It is obvious from the definition of the appended claims that embodiments with such modifications also belong to the scope of the present invention.

1. A problem solving support apparatus for supporting problem solving for electronic device users based on user input on how to use the device, comprising:
a related icon storage section which stores a plurality of icons which are images having appearance conceptually associated with at least a part of an entry word, in association with the entry word which specifies problem solving functions of the electronic device;
a candidate icon display section which displays at least some icons that are candidates for accepting selections from outside on a screen; and
an entry word extract section to extract the entry word and display the extracted entry word based on combinations of two or more icons are which refers to the related icon storage section to extract the entry word and display the extracted entry word based on combinations of two or more icons when two or more icons when two or more icons are selected from the icons on the screen displayed by said candidate icon display section, wherein
said candidate icon display section divides the plurality of icons into at least two groups and separately displays them.

2. The problem solving support apparatus as claimed in claim 1, wherein said candidate icon display section expands the display area of other groups when the icon is selected from one of the two or more icons.

3. The problem solution support apparatus as claimed in claim 1, wherein said candidate icon regulating section refers to said related icon storage section, extracts other icons which correspond to the entry word corresponding to the selected icon, compares the number of the icons in the two or more groups which is distinguished by said candidate icon display section, and expands and displays the display area of the group with the greater number of extracted icons when the icon is selected from a group of the two or more groups.

4. The problem solution support apparatus as claimed in claim 1, wherein said candidate icon display section displays a first group of the two or more groups as a group of action icons indicating the action of the function specified by the entry word and displays a second group of the two or more groups as a target icon group indicating the target of the function specified by the entry word.

5. The problem solution support apparatus as claimed in claim 1, wherein said related icon storage section distinguishes the action icon and the target icon, associates each of them with the entry word, and stores them.

6. The problem solution support apparatus as claimed in claim 1, wherein said related icon storage section comprises:
an entry word storage section which associates action element words indicating the actions of functions specified by the entry word and target element words indicating the targets of functions specified by the entry word with the entry word and stores them; and
a corresponding element word storage section which stores the target icons having an appearance associated with the targets shown by the target element words which are associated with the action icons which conceptually indicate the actions of functions specified by the entry word and the target element words, wherein
said entry word extract section extracts the action element words which are associated with selected the action icons from said corresponding element word storage section, extracts the entry words which are associated with all extracted the element words from said entry word storage section, and displays extracted the entry words when the action icon is selected.

7. An article comprising: a storage medium having a plurality of machine readable instructions executed on a problem solution support apparatus for supporting problem solutions for electronic device users based on user input on how to use the device, wherein when the instructions are executed by a machine, cause said problem solution support apparatus to perform functions comprising:
a related icon storage function which stores a plurality of icons, which are images with appearance conceptually associated with at least a part of an entry word, in association with the entry word which specifies problem solving functions of the electronic device;
a candidate icon display function which displays at a part of plurality of icons that are candidates for accepting selections from outside on a screen; and
an entry word extract function which refers to said related icon storage section to extract the entry word and display the extracted entry word based on combinations of two or more icons when the two or more icons are selected from the icons on the screen displayed by the candidate icon display section, wherein
said candidate icon display function divides the plurality of icons into two or more groups and displays them.
